(19) United States
(12) Patent Application Publication
(10) Pub. No.: US 2016/0202557 A1
(43) Pub. Date: Jul. 14, 2016

(54) LIQUID CRYSTAL DISPLAY AND METHOD OF MANUFACTURING THE SAME

(71) Applicant: SAMSUNG DISPLAY CO., LTD., Yongin-City (KR)

(72) Inventors: JEONG HO LEE, Seoul (KR); Hyang Yul Kim, Hwaseong-Gi (KR); Jun Ho Song, Seongnam-Si (KR)

(21) Appl. No.: 14/806,198

(22) Filed: Jul. 22, 2015

(30) Foreign Application Priority Data
Jan. 8, 2015 (KR) 10-2015-0002981

(51) Int. Cl. G02F 1/1337; G02F 1/1368; G02F 1/1335

(52) U.S. Cl. CPC G02F 1/133753; G02F 1/133528; G02F 1/1368; G02F 1/133788; G02F 2001/133531; G02F 2001/133757; G02F 2001/136222

(57) ABSTRACT

A liquid crystal display, according to an exemplary embodiment of the present invention, includes a first transparent substrate having an image displaying part and a transmitting part, and a second transparent substrate opposite to the first transparent substrate. A liquid crystal layer is formed between the first transparent substrate and the second transparent substrate. A first polarizing plate is disposed on a side of the first transparent substrate. A second polarizing plate is disposed on a side of the second transparent substrate. The transmitting part is in a normally white mode in which light travels through the liquid crystal layer in an absence of an electrical field provided thereacross.

### CROSS-REFERENCE TO RELATED APPLICATION(S)

This application claims priority under 35 U.S.C. §119 to Korean Patent Application No. 10-2015-0002981, filed in the Korean Intellectual Property Office on Jan. 8, 2015, the contents of which are incorporated by reference herein in their entirety.

### TECHNICAL FIELD

Exemplary embodiments of the present invention relate to liquid crystal, and more particularly, to a liquid crystal display and a method of manufacturing the same.

### DISCUSSION OF THE RELATED ART

A liquid crystal display, which is one of the most widely used flat panel displays, may include two display panel sheets on which electrodes such as pixel electrodes, common electrodes, or the like, may be formed. A liquid crystal layer may be interposed between the two panel sheets. The electrodes may generate an electric field.

The liquid crystal display displays an image by applying a voltage to the electric field generating electrodes to generate an electric field on the liquid crystal layer. The electric field may change an orientation of liquid crystal molecules of the liquid crystal layer and thereby control polarization of incident light.

The liquid crystal display may be manufactured to be thin. However, the liquid crystal display may have a drawback. For example, the liquid crystal display may have a side visibility that may be lower than a front visibility. A method for arranging and driving a liquid crystal has been developed to solve the above-mentioned drawback, (e.g., to increase side visibility by providing a wide viewing angle of the liquid crystal display). For example, a method for creating a liquid crystal display of a horizontal alignment type having a wide viewing angle has been developed. In a liquid crystal display having a horizontal alignment type, long axes of liquid crystal molecules may be arranged to be parallel to a display panel in a state in which an electric field is not applied thereto.

Since the above-mentioned liquid crystal display is not self-emitting, a separate light source may be required to illuminate the display. However, light provided by the separate light source may be lost due to it being reflected, absorbed, scattered, or the like, when passing (e.g., being transmitted) through the liquid crystal display device.

### SUMMARY

Exemplary embodiments of the present invention relate to a liquid crystal display having good transmittance by reducing loss of light passing through the liquid crystal display and a method of manufacturing the same.

According to an exemplary embodiment of the present invention, a liquid crystal device includes a first transparent substrate having an image displaying part and a transmitting part, and a second transparent substrate opposite to the first transparent substrate. The liquid crystal device includes a liquid crystal layer formed between the first transparent substrate and the second transparent substrate. A first polarizing plate is disposed on a side of the first transparent substrate. A second polarizing plate is disposed on a side of the second transparent substrate. The transmitting part is in a normally white mode in which light travels through the liquid crystal layer in an absence of an electrical field provided thereacross.

According to an exemplary embodiment of the present invention, the liquid crystal display may further include a common electrode having an opening part in the transmitting part.

According to an exemplary embodiment of the present invention, the first polarizing plate and the second polarizing plate may be linear polarizing plates and may have polarization axes directions which are perpendicular to each other. Liquid crystal molecules of the liquid crystal layer of the transmitting part of the liquid crystal layer may be aligned at an angle of 40° or more to 50° or less with respect to a polarization axis direction of the first polarizing plate or a polarization axis direction of the second polarizing plate.

According to an exemplary embodiment of the present invention, the image displaying part may be in a normally black mode. In a normally black mode, light may be blocked by the liquid crystal layer in an absence of an electrical field provided thereacross.

According to an exemplary embodiment of the present invention, the image displaying part and the transmitting part may include the same liquid crystal molecules in the liquid crystal layer. An alignment direction of a liquid crystal molecule of the liquid crystal layer of the image displaying part may be different from an alignment direction of a liquid crystal molecule of the liquid crystal layer of the transmitting part.

According to an exemplary embodiment of the present invention, the polarization axis of the first polarizing plate and the polarization axis of the second polarizing plate may be perpendicular to each other. The liquid crystal molecules of the liquid crystal layer of the transmitting part may be aligned at an angle of 40° or more to 50° or less with respect to a polarization axis direction of the first polarizing plate or a polarization axis direction of the second polarizing plate. The liquid crystal molecules of the image displaying part of the liquid crystal layer may be aligned at an angle of −5° or more to 5° or less with respect to a polarization axis direction of the first polarizing plate or a polarization axis direction of the second polarizing plate.

According to an exemplary embodiment of the present invention, the image displaying part may include a thin film transistor formed on an inner side of the first transparent substrate. A pixel electrode may be formed on the thin film transistor and a color filter formed on an inner side of the first transparent substrate or the second transparent substrate.

According to an exemplary embodiment of the present invention, the liquid crystal display may include a common electrode, wherein the common electrode may have an opening part in the transmitting part.

According to an exemplary embodiment of the present invention, the common electrode and the pixel electrode may overlap with each other. The common electrode and the pixel electrode may have an insulating layer disposed therebetween.

According to an exemplary embodiment of the present invention, the transmitting part may further include a transparent layer.

According to an exemplary embodiment of the present invention, an area of the image displaying part may be formed at a ratio of 5:5 to 8:2 and an area of the transmitting part may be formed at a ratio of 5:5 to 8:2.

According to an exemplary embodiment of the present invention, the transmitting part may have a transmittance of 5% or more to 20% or less of an incident light source.

According to an exemplary embodiment of the present invention, when an electric field is applied between the common electrode and the pixel electrode, a total of transmittance of the image displaying part and the transmitting part may be increased from 5% to 40% of the incident light source by driving the image displaying part.

According to an exemplary embodiment of the present invention, the liquid crystal layer of the transmitting part of the liquid crystal layer may have a thickness of 3 μm or more to 4 μm or less.

According to an exemplary embodiment of the present invention, the first polarizing plate and the second polarizing plate may be linear polarizing plates and may have polarization axes directions which are perpendicular to each other. The liquid crystal molecules of the transmitting part of the liquid crystal layer may be aligned in a twisted nematic (TN) mode.

According to an exemplary embodiment of the present invention, a method of manufacturing a liquid crystal display includes forming a first alignment layer on an inner side of a first transparent substrate. The first transparent substrate has an image displaying part and a transmitting part. The method of manufacturing a liquid crystal display includes disposing a first polarizing plate having a polarization axis extend along a first direction on a side of the first transparent substrate, and disposing a second polarizing plate having a second polarization axis on a side of a second transparent substrate. The second transparent substrate is opposite to the first transparent substrate. The first and second polarizing axes are perpendicular to each other. Forming the first alignment layer includes having the first alignment layer irradiated by polarized light in a direction forming an angle of −5° or more to 5° or less with respect to either the first polarization axis or the second polarization axis using a mask having an image displaying part of the first alignment layer at a maximum gray scale and having a transmitting part of the first alignment layer at a minimum gray scale. The method of manufacturing a liquid crystal display includes having the first alignment layer irradiated by polarized light in a direction forming an angle of 40° or more to 50° or less with respect to either the first polarization axis or the second polarization axis using a mask having the image displaying part of the first alignment layer at the minimum gray scale and having the transmitting part of the first alignment layer at the maximum gray scale.

According to an exemplary embodiment of the present invention, the method may further include forming a second alignment layer on an inner side of the second transparent substrate. Forming the second alignment layer includes having the second alignment layer radiated by polarized light in a direction forming an angle of −5° or more to 5° or less with respect to either the first polarization axis or the second polarization axis using a mask having an image displaying part of the second alignment layer at a maximum gray scale. The method of manufacturing a liquid crystal display includes having a transmitting part of the second alignment layer at a minimum gray scale, and having the second alignment layer radiated by polarized light in a direction forming an angle of 40° or more to 50° or less with respect to either the first polarization axis or the second polarization axis using a mask having the image displaying part of the first alignment layer at the minimum gray scale. The method of manufacturing a liquid crystal display includes having the transmitting part of the first alignment layer at the maximum gray scale.

According to an exemplary embodiment of the present invention, a liquid crystal display includes a first transparent substrate having an image displaying part and a transmitting part, a second transparent substrate, and a liquid crystal layer formed between the first transparent substrate and the second transparent substrate. The liquid crystal display includes a first polarizing plate disposed below the first transparent substrate, and a second polarizing plate disposed above the second transparent substrate. The image displaying part includes a pixel electrode disposed between the first transparent substrate and the second transparent substrate. The image displaying part includes a common electrode disposed between the first transparent substrate and the second transparent substrate. The transmitting part does not have a pixel electrode and a common electrode.

According to an exemplary embodiment of the present invention, the total transmittance of the image displaying part and the transmitting part may be increased from 5% to 40% of the incident light source by driving the image displaying part.

According to an exemplary embodiment of the present invention, an area of the image displaying part may be formed at a ratio of 5:5 to 8:2 and an area of the transmitting part may be formed at a ratio of 5:5 to 8:2.

### BRIEF DESCRIPTION OF THE DRAWINGS

FIG. 1 is a plan view schematically showing a liquid crystal display according to an exemplary embodiment of the present invention.

FIG. 2 is an enlarged plan view schematically illustrating an image displaying part and a transmitting part of the liquid crystal display shown in FIG. 1, according to an exemplary embodiment of the present invention.

FIG. 3 is a cross-sectional view taken along a line II-II′ of FIG. 2, according to an exemplary embodiment of the present invention.

FIG. 4 is an enlarged view schematically showing liquid crystal molecules of the image displaying part C of FIG. 3, a first polarizing plate and a second polarizing plate disposed on and below the liquid crystal molecules, according to an exemplary embodiment of the present invention.

FIG. 5 is an enlarged view schematically showing liquid crystal molecules of the transmitting part T of FIG. 3, a first polarizing plate and a second polarizing plate disposed on and below the liquid crystal molecules, according to an exemplary embodiment of the present invention.

FIG. 6 is an enlarged layout view of the image displaying part and the transmitting part of a liquid crystal display according to an exemplary embodiment of the present invention.

FIG. 7 is a cross-sectional view taken along a line VII-VII′ of FIG. 6, according to an exemplary embodiment of the present invention.

FIG. 8 is an enlarged view schematically showing the first polarizing plate, the second polarizing plate, and the liquid crystal molecules injected between the first polarizing plate and the second polarizing plate of the transmitting part T of FIG. 6, according to an exemplary embodiment of the present invention.

FIG. 9 is a view schematically showing a mask used in a method of manufacturing a liquid crystal display according to an exemplary embodiment of the present invention.

### DETAILED DESCRIPTION OF THE EMBODIMENTS

Exemplary embodiments of the present invention will be described in detail with reference to the accompanying drawings to convey the present invention to those skilled in the art. However, the present invention is not limited to the exemplary embodiments which are described herein. Exemplary embodiments of the present invention may be modified in various different ways without departing from the spirit of the present invention.

Accordingly, the drawings and the detailed description thereof are illustrative in nature. Exemplary embodiments of the present invention are not limited to the configurations and elements described herein. Like reference numerals may refer to like elements throughout the specification.

In several exemplary embodiments of the present invention, components having the same configuration will be described by the same reference numerals.

Sizes and thicknesses of the respective components shown in the drawings may be arbitrarily displayed for the convenience of explanation. The sizes and the thicknesses may be exaggerated to clearly illustrate several layers and regions in the drawings. However, the present invention is not limited to the elements shown in the drawings.

When it is stated that a portion of a layer, a film, a region, a plate, or the like is present “on”, “over”, and “below” another portion, the portion of the layer, film, region, plate, or the like, may be directly formed on another portion of another layer, film, plate, or the like, or may have the layers interposed therebetween.

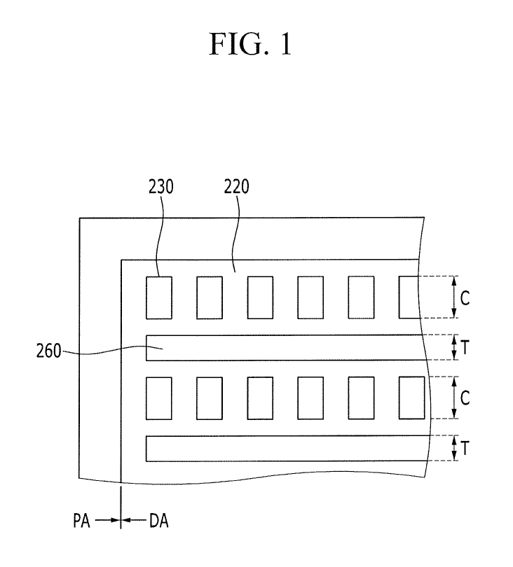

A liquid crystal display and a method of manufacturing the same according to an exemplary embodiment of the present invention will be described with reference to FIG. 1.

FIG. 1 is a plan view schematically showing a liquid crystal display according to an exemplary embodiment of the present invention.

Referring to FIG. 1, the liquid crystal display according to an exemplary embodiment of the present invention includes a display region DA and a non-display region PA. The display region DA includes image displaying parts C and transmitting parts T. A light blocking member 220 may be formed between the image displaying part C and the transmitting part T so that unnecessary light is not transmitted. The image displaying part C includes a plurality of pixels, wherein one pixel has color filters 230 of red, green, and blue, respectively, which are repeatedly arranged along a direction of a row. The transmitting part T may have transparent layers 260, which are arranged to alternate with the image displaying part C along a direction of a column. According to an exemplary embodiment of the present invention, with reference to FIG. 1, the image displaying parts C having the plurality of pixels are disposed in an odd-numbered row, the transmitting parts T are disposed in an even-numbered row, and the transmitting part T extends in one whole row. According to an exemplary embodiment of the present invention, the image displaying part C may be disposed in an odd-numbered column and the transmitting part T may be disposed in an even-numbered column. In addition, the transmitting part T does not extend in one whole row or column, but may extend the length of one pixel or may extend the length of three pixels of red, green, and blue. The image displaying part C and the transmitting part T may be variously formed without departing from the scope of the present invention. The light blocking member 220 may prevent light from leaking into regions other than the image displaying part C and the transmitting part T. The light blocking member 220 may define regions of the image displaying part C and the transmitting part T.

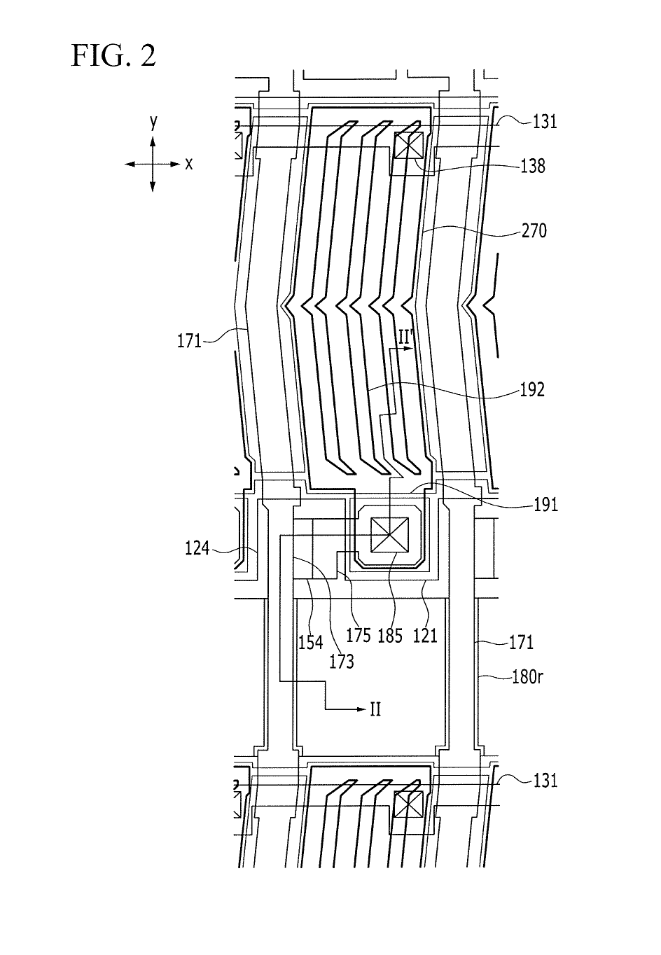

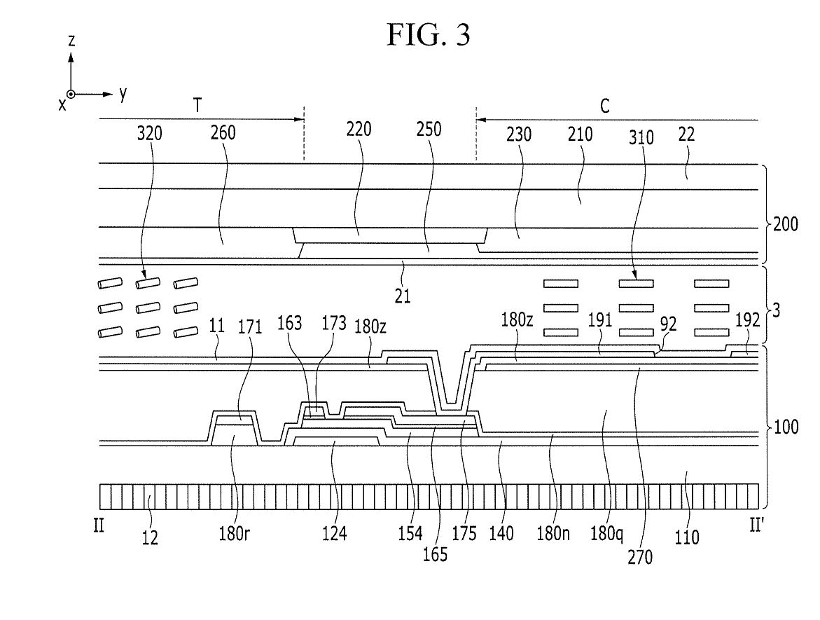

An arrangement structure and a stacked structure of the image displaying part C and the transmitting part T of the liquid crystal display, according to an exemplary embodiment of the present invention, will be described with reference to FIGS. 2 and 3.

FIG. 2 is an enlarged layout view of an image displaying part and a transmitting part of the liquid crystal display, as shown in FIG. 1. FIG. 3 is a cross-sectional view taken along a line II-II′ of FIG. 2, according to an exemplary embodiment of the present invention.

The liquid crystal display, according to an exemplary embodiment of the present invention, includes a first display panel 100 and a second display panel 200 that face each other, and a liquid crystal layer 3 injected therebetween.

The image displaying part C will be described.

The first display panel 100 will be described. A first polarizing plate 12 may be formed on an outer side of a first transparent substrate 110. The first transparent substrate 110 may include transparent glass, plastics, or the like. The first polarizing plate 12 may be a linear polarizing plate and a polarization axis thereof may extend along an x axis direction. The first polarizing plate 12 may be formed on an outer side of the first transparent substrate 110, according to an exemplary embodiment of the present invention. However, the first polarizing plate 12 may also be formed on an inner side of the first transparent substrate 110, according to an exemplary embodiment of the present invention.

A gate conductor including a gate line 121 may be formed on the first transparent substrate 110.

The gate line 121 may include a gate electrode 124 having a wide end portion for connecting with other layers or external driving circuits. The gate line 121 may include an aluminum (Al) based metal such as aluminum, an aluminum alloy, or the like. The gate line 121 may include a silver (Ag) based metal such as silver, a silver alloy, or the like. The gate line 121 may include a copper (Cu) based metal such as copper, a copper alloy, or the like. The gate line 121 may include a molybdenum (Mo) based metal such as molybdenum, a molybdenum alloy, or the like. The gate line 121 may include chromium (Cr), tantalum (Ta), titanium (Ti), or the like. The gate line 121 may have a multilayer structure including at least two conductive layers having different physical properties.

A gate insulating layer 140 including silicon nitride (SiNx) or silicon oxide (SiOx) may be formed on the gate conductor. The gate insulating layer 140 may have a multilayer structure including at least two insulating layers having different physical properties.

A semiconductor 154 including amorphous silicon, polycrystal silicon, or the like, may be formed on the gate insulating layer 140. The semiconductor 154 may include an oxide semiconductor.

Ohmic contacts 163 and 165 may be formed on the semiconductor 154. The ohmic contacts 163 and 165 may include a material such as n+ hydrogenated amorphous silicon which is heavily doped with n-type impurities such as phosphorus. The ohmic contacts 163 and 165 may include silicide. The ohmic contacts 163 and 165 may be disposed in pairs on the semiconductor 154. According to an exemplary embodiment of the present invention, when the semiconductor 154 includes the oxide semiconductor, the ohmic contacts 163 and 165 may be omitted.

The data line 171 includes the source electrode 173. The source electrode 173 may be formed on the ohmic contact 163. A data conductor includes the drain electrode 175. The drain electrode 175 may be formed on the ohmic contact 165.

The data line 171 may include a wide end portion for a connection with other layers or external driving circuits. The data line 171 may transfer a data signal and may extend in a vertical direction to intersect with the gate line 121. A third passivation layer 180r may be formed below the data line 171, extended to the transmitting part T, to maintain a height of the data line 171. The third passivation layer 180r may include an organic insulating material, an inorganic insulating material, or the like.

The data line 171 may have a first curved part having a curved shape to obtain maximum transmittance of the liquid crystal display. The data line 171 may have a second curved part which is curved at a middle region of the pixel region. The second curved part of the data line 171 may form a predetermined angle with the first curved part of the data line 171. The first and second curved parts of the data line 171 may intersect with each other at a middle region of a pixel region, forming a V shape.

As shown in FIG. 2, the first curved part of the data line 171 may be curved to form an angle of about 7° with respect to a vertical reference line y (e.g., a reference line extended in a y direction). The vertical reference line y may cross a reference line x, (e.g., a reference line extended in an x direction). The vertical reference line y may cross the reference line x at angle of 90°. The gate line 121 may extend along the x direction. The second curved part of the data line 171 may be disposed in the middle region of the pixel region and may be further curved to form an angle of about 7° to 15° with respect to the first curved part of the data line 171.

The source electrode 173 is a portion (e.g., a branch) of the data line 171 and is disposed on the same line as the data line 171. The drain electrode 175 may be parallel to the source electrode 173. Therefore, the drain electrode 175 may be parallel to the portion of the data line 171 which corresponds to the source electrode 173.

The gate electrode 124, the source electrode 173, and the drain electrode 175 form a thin film transistor (TFT) together with the semiconductor 154. A channel of the TFT may be formed in the semiconductor 154 between the source electrode 173 and the drain electrode 175.

The data line 171 and the drain electrode 175 may be made of a refractory metal such as molybdenum, chromium, tantalum, titanium, or the like, or an alloy thereof. The data line 171 and the drain electrode 175 may have a multilayer structure including a refractory metal layer and a low resistance conductive layer. The multilayer structure of each of the data line 171 and the drain electrode 175 may include a double layer of a chromium or molybdenum (e.g., an alloy) lower layer and an aluminum (e.g., an alloy) upper layer. The multilayer structure of each of the data line 171 and the drain electrode 175 may also include a triple layer of a molybdenum (e.g., an alloy) lower layer, an aluminum (e.g., an alloy) middle layer, and a molybdenum (e.g., an alloy) upper layer. However, the data line 171 and the drain electrode 175 may include various metals or conductors in addition to those described above. The data line 171 may have a width of about 3.5 μm+0.75 μm.

A first passivation layer 180n may be disposed on the exposed portions of the data conductors 171, 173, and 175, the gate insulating layer 140, and the semiconductor 154. The first passivation layer 180n may include an organic insulating material, an inorganic insulating material, or the like. According to an exemplary embodiment of the present invention, the first passivation layer 180n may be omitted.

The second passivation layer 180q may be disposed on the first passivation layer 180n. The second passivation layer 180q may be made of a flat organic insulating material, an inorganic insulating material, or the like. The second passivation layer 180q may be a color filter of the image displaying part C. In the case in which a portion of the second passivation layer 180q is a color filter, the second passivation layer 180q may display one primary color. The primary colors may include three primary colors such as red, green, and blue, or yellow, cyan, magenta, or the like. The color filter may further include a color filter displaying a mixed color of the primary colors, in addition to the primary colors.

A common electrode 270 may be formed on the second passivation layer 180q. The common electrode 270, which may include a planar shape, may be formed on a front surface of the first transparent substrate 110, corresponding to the image displaying part C, as a tub plate. The common electrode 270 may have opening portions in a region around the drain electrode 175. For example, the common electrode 270 may be planar and shaped like a disc.

The common electrodes 270, disposed in pixels which are adjacent to each other, may be connected to each other to receive a predetermined magnitude of common voltage supplied from the outside of the display region.

A fourth passivation layer 180z may be disposed on the common electrode 270. The fourth passivation layer 180z may include an organic insulating material, an inorganic insulating material, or the like.

A pixel electrode 191 may be formed on the image displaying part C on the fourth passivation layer 180z. The pixel electrode 191 may include a curved edge which may be substantially parallel to the first curved part and/or the second curved part of the data line 171. The pixel electrode 191 may have a plurality of first cut parts 92 and includes a plurality of first branch electrodes 192, defined by the plurality of first cut parts 92.

The first passivation layer 180n, the second passivation layer 180q, and the fourth passivation layer 180z may have contact holes 185 formed therein to expose the drain electrode 175. The pixel electrode 191 may be physically and electrically connected to the drain electrode 175 through the contact hole 185. The pixel electrode 191 is applied with a voltage from the drain electrode 175.

According to an exemplary embodiment of the present invention, the plurality of first branch electrodes 192 of the pixel electrode 191 are connected to each other by connecting parts, respectively, at an upper portion and a lower portion. In addition, the pixel electrode 191 may have the connecting parts or contacting parts extending from the first branch electrodes 192, wherein the contacting part may be electrically connected to the drain electrode 175 through the contact hole 185 as described above.

A first alignment layer 11 may be disposed on the pixel electrode 191 and on the fourth passivation layer 180z. The first alignment layer 11 may be a horizontal alignment layer, may include a photoreaction material, and may be formed by a photo-alignment.

A portion corresponding to the image displaying part C of the first alignment layer 11 may form an angle of 0° with respect to a y axis. The y axis may correspond to a polarization axis of the second polarizing plate 22 to be described below.

Positive liquid crystal molecules may be injected in the liquid crystal layer 3, between the first display panel 100 and the second display panel 200. The first display panel 100 and the second display panel 200 face each other. The liquid crystal molecules in the liquid crystal layer 3 may be aligned in a predetermined direction by an alignment layer. For example, the liquid crystal molecules 310 in a portion of the liquid crystal layer 3 that corresponds to the image displaying part C may be aligned by a portion of the first alignment layer 11 that corresponds to the image display part C. Thus, a direction of a long axis of the liquid crystal molecules of the liquid crystal layer 3 of the image displaying part C may form an angle of 0° with respect to the y axis. The polarization axis of the second polarizing plate 22 may extend along the y axis.

The second display panel 200 will be described. The second polarizing plate 22 may be formed on an outer side of a second transparent substrate 210. The second transparent substrate 210 may include transparent glass, plastics, or the like. The second polarizing plate 22 may be a linear polarizing plate and a polarization axis thereof may extend along the y axis direction. The polarization axis of the second polarizing plate 22 may be perpendicular to the polarization axis of the first polarizing plate 12. The second polarizing plate 22 may also be formed on an inner side of the second transparent substrate 210.

A light blocking member 220 may be formed on the second transparent substrate 210. The light blocking member 220 may also be called a black matrix and may prevent light leakage.

A plurality of color filters 230 may be formed on an upper portion of the second transparent substrate 210 which corresponds to a portion of the image displaying part C. In the case in which a portion of the second passivation layer 180q of the first display panel 100 is a color filter, the color filter 230 of the second display panel 200 may be omitted. In addition, the light blocking member 220 of the second display panel 200 may also be formed on the first display panel 100.

An overcoat 250 may be formed on the color filter 230 and on the light blocking member 220. The overcoat 250 may include an insulating material such as an organic insulating material. The overcoat 250 may prevent the color filter 230 from being exposed and may provide a flat surface. The overcoat 250 may be omitted.

A second alignment layer 21 may be disposed on the overcoat 250. The second alignment layer 21 may be similar to the first alignment layer 11 described above. The second alignment layer 21 may align the liquid crystal molecules of the liquid crystal layer 3 in a predetermined direction. A liquid crystal display may include the first alignment layer 11 but might not include the second alignment layer 22. A liquid crystal display may include the second alignment layer 22 but might not include the first alignment layer 11. According to an exemplary embodiment of the present invention, a liquid crystal display may include the first alignment layer 11 and the second alignment layer 22.

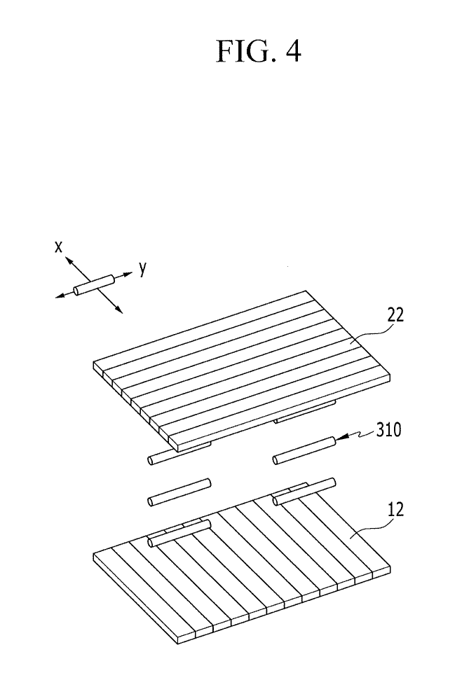

How the image displaying part C is driven will be described with reference to FIGS. 3 and 4. FIG. 4 is an enlarged view schematically showing liquid crystal molecules 310 of the image displaying part C of FIG. 3, a first polarizing plate 12 and a second polarizing plate 22 disposed below and on the liquid crystal molecules 310, in that order, according to an exemplary embodiment of the present invention As shown in FIG. 4, a first polarizing plate 12 and a second polarizing plate 22 may be disposed below and on the liquid crystal molecules 310, respectively.

Referring to FIG. 4, the image displaying part C includes a first polarizing plate 12 having a polarization axis extending along an x axis direction, a second polarizing plate 22 having a polarization axis extending along a y axis direction, and liquid crystal molecules 310 of the image displaying part C which may be aligned in a direction parallel to the polarization axis of the second polarizing plate 22. A backlight, which is a light source, may be disposed below the first display panel 100. When no voltage is applied to the liquid crystal molecules 310 of the image displaying part C, light emitted from the backlight is polarized in the x axis direction by the first polarizing plate 12 and the polarized light does not pass through the liquid crystal molecules 310 of the image displaying part C. The alignment direction of the liquid crystal molecules 310 is perpendicular to the polarized light and to the polarization axis of the second polarizing plate 22. Therefore, when voltage is not applied to the image displaying part C, the image displaying part C displays black. Displaying black when voltage is not applied across the liquid crystal is referred to as a normally black mode.

A thickness of the liquid crystal layer of the image displaying part C may be 3.25 μm. However, the present invention is not limited thereto. The thickness of the liquid crystal layer of the image displaying part C may be arbitrarily modified without departing from the scope of the present invention.

The pixel electrode 191 may be applied with a data voltage from the drain electrode 175. The common electrode 270 may be applied with a predetermined magnitude of common voltage from a common voltage applying part disposed outside of the display region.

The pixel electrode 191 and the common electrode 270, which are electric field generating electrodes, may generate an electric field which may rotate the liquid crystal molecules 310 of the image displaying part C in a direction which is in parallel to a direction of the electric field. The liquid crystal molecules 310 of the image displaying part C may be disposed between the pixel electrode 191 and the common electrode 270. Polarization of light passing through the liquid crystal molecules 310 of the image displaying part C may be changed depending on the alignment (e.g., rotated) direction of the liquid crystal molecules 310. The alignment direction of the liquid crystal molecules 310 may rotate according to an electric field as described above.

The transmitting part T will be described.

The first display panel 100 will be described. A first polarizing plate 12 may be formed on an outer side of the first transparent substrate 110. The first polarizing plate 12 may be a linear polarizing plate. The a polarization axis of the first polarizing plate 12 may extend along the x axis direction.

The data line 171 of the image displaying part C may be formed and may extend on the first transparent substrate 110 of the transmitting part T. A third passivation layer 180r may be formed below the data line 171 of the transmitting part T to maintain a height of the data line 171. The third passivation layer 180r may include an organic insulating material, an inorganic insulating material, or the like.

The first passivation layer 180n may be disposed on the data line 171. The first passivation layer 180n may include an organic insulating material, an inorganic insulating material, or the like. In an exemplary embodiment of the present invention, the first passivation layer 180n may be omitted.

The second passivation layer 180q may be disposed on the first passivation layer 180n. The second passivation layer 180q may include a flat organic insulating material, an inorganic insulating material, or the like. The transmitting part T of the second passivation layer 180q may be a transparent layer.

A common electrode 270 is not formed on the second passivation layer 180q of the transmitting part T. The common electrode 270, which may have a planar shape, and may be formed as a tub plate on a front surface of the transparent substrate 110, which corresponds to image display part C. However, the common electrode 270 is not formed in the transmitting part T.

The fourth passivation layer 180z, corresponding to the image displaying part C, may be extended on the transmitting part T and may be disposed on the second passivation layer 180q corresponding to the transmitting part T. The fourth passivation layer 180z corresponding to the transmitting part T may be omitted.

The pixel electrode 191 is not formed on the fourth passivation layer 180z of the transmitting part T.

The first alignment layer 11 may be disposed on the fourth passivation layer 180z. The first alignment layer 11 may be a horizontal alignment layer and may include a photoreaction material. The first alignment layer 11 may be formed by a photo-alignment process.

A portion of the first alignment layer 11 corresponding to the transmitting part T may form an angle of 40° or more to 50° or less with respect to the x axis. The polarization axis of the first polarizing plate 12 may correspond to the x axis.

Positive liquid crystal molecules may be injected into the liquid crystal layer 3 between the first display panel 100 and the second display panel 200 that face each other. The liquid crystal molecules in the liquid crystal layer 3 may be aligned in a predetermined direction by the alignment layer. For example, the liquid crystal molecules 310 in the portion of the liquid crystal layer 3 that corresponds to the transmitting part T may be aligned by the first alignment layer 11 that corresponds to the transmitting part T. The liquid crystal molecules of the liquid crystal layer 3 corresponding to the transmitting part T may be aligned such that a direction of a long axis thereof may form an angle of 40° or more to 50° or less with respect to the x axis. The polarization axis of the first polarizing plate 12 extends along the x axis.

The second display panel 200 will be described. The second polarizing plate 22 may be formed on an outer side of a second transparent substrate 210. The second polarizing plate 22 may be a linear polarizing plate and a polarization axis thereof may extend along the y axis direction. The polarization axis of the second polarizing plate 22 may be perpendicular to the polarization axis of the first polarizing plate 12.

The transparent layer 260 may be formed on the upper portion of the second transparent substrate 210 which corresponds to the transmitting part T. The transparent layer 260 may include a transparent organic layer and may be flat. However, a material of the transparent layer 260 is not limited to the transparent organic layer. For example, as long as a material is transparent, the material may be used in the transparent layer 260. Also, an inorganic layer may also be used in the transparent layer 260. The transparent layer 260 may be omitted. The transparent layer 260 may be flat and may cover the light blocking member 220 and the color filter 230 of the image displaying part C. In the case in which the transparent layer 260 covers the light blocking member 220 and the color filter 230 of displaying part C, the overcoat 250 formed on the color filter 230 and the light blocking member 220 may be omitted.

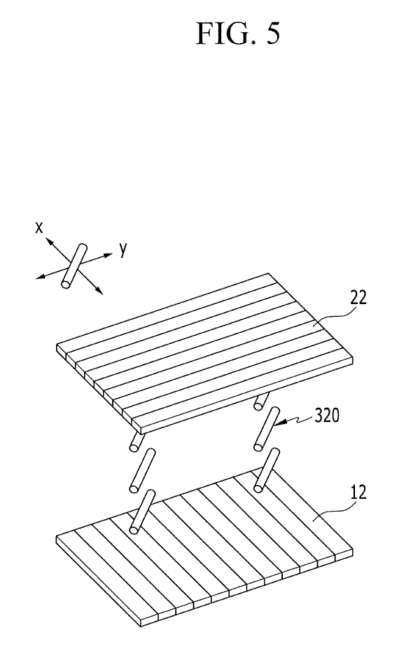

A second alignment layer 21 may be disposed on the overcoat 250. The second alignment layer 21 may be the same alignment layer as the first alignment layer 11 of the transmitting part T described above. The alignment layer may align the liquid crystal molecules of the liquid crystal layer 3 in a predetermined direction. One alignment layer may be sufficient to align the molecules of the liquid crystal layer 3, corresponding to the transmitting part T, in a predetermined direction. For example, either the second alignment layer 21 or the first alignment layer 11, corresponding to the transmitting part T, may be used. However, according to an exemplary embodiment of the present invention, both the second alignment layer 21 and the first alignment layer 11, corresponding to the transmitting part T, may be used. How the transmitting part T is driven will be described with reference to FIGS. 3 and 5. FIG. 5 is an enlarged view schematically showing liquid crystal molecules 320 of the transmitting part T of FIG. 3, a first polarizing plate 12 and a second polarizing plate 22 that are disposed below and on the liquid crystal molecules 320, in that order, according to an exemplary embodiment of the present invention. A first polarizing plate 12 may be disposed below the liquid crystal molecules 320 and a second polarizing plate 22 may be disposed on the liquid crystal molecules 320.

Referring to FIG. 5, the transmitting part T may include a first polarizing plate 12 having a polarization axis that may extend along an x axis direction, a second polarizing plate 12 having a polarization axis that may extend along a y axis direction, and liquid crystal molecules 320 of the transmitting part T which may be aligned in a direction to form an angle of 45° with respect to the x axis. When no voltage is applied to the liquid crystal molecules 320 of the transmitting part T, and when light emitted from the backlight is polarized in the x axis direction by the first polarizing plate 12, a phase lag may occur while the polarized light passes through the liquid crystal molecules 320 of the transmitting part T. The phase lagged light passes through the polarization axis of the second polarizing plate 22. When voltage is not applied to the transmitting part T, the transmitting part T displays white. Displaying the white when no voltage is applied across the liquid crystal is referred to as a normally white mode.

A thickness of the liquid crystal layer of the transmitting part T may be 2.5 μm. The above-mentioned thickness may correspond to a thickness in which the positive liquid crystal molecules having a difference in length of 0.109 between a long axis and a short axis may exhibit maximum transmittance, based on green light having a wavelength of 555 nm. However, the present invention is not limited thereto. The thickness of the liquid crystal layer of the transmitting part T may be arbitrarily modified in a range in which the transmitting part T may transmit light when no voltage is applied thereto. The thickness of the liquid crystal layer of the transmitting part T may be 3 μm or more to 4 μm or less.

Since the transmitting part T does not have the pixel electrode 191 and the common electrode 270, the liquid crystal molecules 320 in the transmitting part T are not directly influenced by the electric field generated by the pixel electrode 191 and the common electrode 270. Thus, even when voltage is applied to the liquid crystal layer of the image displaying part C, the voltage is not applied to the liquid crystal layer of the transmitting part T and the normally white mode is maintained in the transmitting part T.

An exemplary embodiment of the present invention may include modifications to the liquid crystal display described with reference to FIGS. 1 to 5.

In an exemplary embodiment of the present invention, shown in FIGS. 1 to 5, the polarization axis of the first polarizing plate 12 may extend along the x axis. The polarization axis of the second polarizing plate 22 may extend along the y axis. The long axes of liquid crystal molecules 310 of the image displaying part C may be aligned to form an angle of 0° with respect to the polarization axis of the second polarizing plate 22. The long axes of the liquid crystal molecules 320 of the transmitting part T may be aligned to form an angle of 45° with the polarization axis of the first polarizing plate 12.

According to an exemplary embodiment of the present invention, the long axes of the liquid crystal molecules 310 of the image displaying part C may be aligned in a direction to form an angle of 0° with respect to the polarization axis of the first polarizing plate 12. The reason is that as long as the liquid crystal molecules 310 of the image displaying part C are parallel to the polarization axis of any one of the first polarizing plate 12 and the second polarizing plate 22, when the first and second polarizing plates 12 and 22 have polarization axes which are perpendicular to each other, light does not pass through the liquid crystal molecules 310. Thus, the normally black mode may be implemented. Similarly, the liquid crystal molecules 310 of the image displaying part C may also be aligned within a range forming an angle of −5° or more to 5° or less, as well as an accurate angle of 0°, with the polarization axis of the first polarizing plate 12 or the second polarizing plate 22. For example, the long axes of the liquid molecules 310 corresponding to the image displaying part C may be aligned within a range forming an angle of −5° or more to 5° or less, as well as an accurate angle of 0°, with the polarization axis of the first polarizing plate 12 or the polarization axis of the second polarizing plate 22, to implement the normally black mode. The reason is that the light does not pass through the liquid crystal molecules 310 even when the long axes of the liquid crystal molecules 310 are rotated within the above-mentioned range with respect to of any of the first or second polarizing plates 12 and 22, Thus, the normally block mode may be implemented.

In addition, the long axes of the liquid crystal molecules 320 of the transmitting part T may be aligned in a direction forming an angle of 45° with the polarization axis of the second polarizing plate 22. The reason is that as long as the liquid crystal molecules 320 of the transmitting part T form the angle of 45° with the polarization axis of any of the first polarizing plate 12 and the second polarizing plate 22, when the first and second polarizing plates 12 and 22 have polarization axes perpendicular to each other, light passes through the liquid crystal molecules 320. Thus, the normally white mode may be implemented. Similarly, the liquid crystal molecules 320 of the transmitting part T may also be aligned within a range forming an angle of 40° or more to 50° or less, as well as an accurate angle of 45°, with respect to the polarization axis of the first polarizing plate 12 or the second polarizing plate 22. For example, the long axes of the liquid crystal molecules 320 corresponding to the transmitting part T may also be rotated within a range of 40° or more to 50° or less, as well as an accurate angle of 45°, with respect to the polarization axis of the first polarizing plate 12 or the second polarizing plate 22 to implement the normally white mode. The reason is that the light passes through the liquid crystal molecules 320 even within the above-mentioned range to implement the normally white mode.

In an exemplary embodiment of the present invention, the polarization axis of the first polarizing plate 12 may extend along the y axis direction and the polarization axis of the second polarizing plate 22 may extend along the x axis direction. In this case, the liquid crystal molecules 310 of the image displaying part C may form the angle of 0° with respect to the polarization axis of any one of the first polarizing plate 12 and the second polarizing plate 22. Also, in this case, the liquid crystal molecules 320 of the transmitting part T may form an angle of 45° with respect to the polarization axis of any one of the first polarizing plate 12 and the second polarizing plate 22. Further, the liquid crystal molecules 310 may form an angle of −5° or more to 5° or less as well as the accurate angle of 0° with respect to the polarization axes and the liquid crystal molecules 320, may form an angle of 40° or more to 50° or less as well as the accurate angle of 45° with respect to the polarization axes.

According to an exemplary embodiment of the present invention, positive liquid crystal molecules are used in the liquid crystal layer 3. In an exemplary embodiment of the present invention, negative liquid crystal molecules may be used. According to an exemplary embodiment of the present invention, when negative liquid crystal molecules are used, the long axes of the liquid crystal molecules 310 of the image displaying part C may be aligned to form an angle of 0° with respect to the polarization axis of the first polarizing plate 12 or the second polarizing plate 22 to implement the normally black mode. The reason is that as long as the liquid crystal molecules 310 of the image displaying part C are parallel to the polarization axis of any one of the first polarizing plate 12 and the second polarizing plate 22, when the first and second polarizing plates have polarization axes perpendicular to each other, the light does not pass through the liquid crystal molecules 310. Thus, the normally black mode may be implemented. Further, the liquid crystal molecules 310 of the image displaying part C may also be aligned within a range forming an angle of −5° or more to 5° or less as well as an accurate angle of 0° with respect to the polarization axis of the first polarizing plate 12 or with the polarization axis of the second polarizing plate 22. The reason is that the light does not pass through the liquid crystal molecules 310 even within the above-mentioned range. Thus, the normally black mode may be implemented. The long axes of the liquid crystal molecules 320 of the transmitting part T may be aligned in a direction forming an angle of 45° with respect to the polarization axis of the first polarizing plate 12 or the polarization axis of the second polarizing plate 22 to implement the normally white mode. The reason is that as long as the liquid crystal molecules 320 corresponding to the transmitting part T form the angle of 45° with respect to the polarization axis of any one of the first polarizing plate 12 and the second polarizing plate, when the first and second polarizing plates 12 and 22 have polarization axes perpendicular to each other, the light passes through the liquid crystal molecules 320 to implement the normally white mode. Further, the liquid crystal molecules 320 of the transmitting part T may also be aligned within a range forming an angle of 40° or more to 50° or less as well as an accurate angle of 45° with respect to the polarization axis of the first polarizing plate 12 or the polarization axis of the second polarizing plate 22. The reason is that the light passes through the liquid crystal molecules 320 even within the above-mentioned range. Thus, the normally white mode may be implemented.

According to an exemplary embodiment of the present invention, with reference to FIGS. 1 to 5, the common electrode 270 may be formed in the image displaying part C and is not formed in the transmitting part T. However, according to an exemplary embodiment of the present invention, the common electrode 270 may also be formed in the transmitting part T. Alternatively, an opening part may also be formed only in the transmitting part T of the common electrode 270, formed on the first transparent substrate 110 as the tub plate.

According to an exemplary embodiment of the present invention, with reference to FIGS. 1 to 5, the image displaying part C is in the normally black mode. According to an exemplary embodiment of the present invention, the image displaying part C is not in the normally black mode. The long axes of the liquid crystal molecules 310 of the image displaying part C may be aligned in any angle with respect to the polarization axis of the second polarizing plate 22 or may be aligned with the polarization axis of the first polarizing plate 12.

According to an exemplary embodiment of the present invention, the image displaying part C is arranged to extend along an odd-numbered row and the transmitting part T is arranged to extend along an even-numbered row. However, according to an exemplary embodiment of the present invention, the image displaying part C may be arranged to extended along an even-numbered row and the transmitting part T may be arranged to extended along an odd-numbered row. In addition, the image displaying part C may be arranged to extend along an odd-numbered column and the transmitting part T may be arranged to extend along an even-numbered column. The image displaying part C may be arranged to extend along the even-numbered column and the transmitting part T may be arranged to extend along the odd-numbered column. Further, the transmitting part T may also be formed to include several transmitting parts in one row. The transmitting parts of the transmitting part T may correspond to pixels. In this case, a red pixel and a transmitting part corresponding to the red pixel, a green pixel and a transmitting part corresponding to the green pixel, a blue pixel and a transmitting part corresponding to the blue pixel, may be alternately arranged in the above-mentioned order, in one row, to form a mosaic configuration. Alternatively, the red pixel, the green pixel, the blue pixel, and a transmitting part corresponding to the red, green and blue pixels, in conjunction with a second red pixel, a second green pixel, a second blue pixel, and a transmitting part corresponding to the second red, the second green, and the second blue pixels, may be formed in the stated order. In addition, the image displaying part C and the transmitting part T may be variously arranged without departing from the scope of the present invention.

According an exemplary embodiment of the present invention, an area of the image displaying part C and an area of the transmitting part T may be formed to have a ratio of 5:5 to 8:2. In this case, transmittance of the transmitting part T may be varied from 5% of an incident light source to 20% of the incident light source. The liquid crystal display having the transmitting part T as described above may have an increased transmittance ranging from 5% of the incident light source to 20% of the incident light source as compared to a liquid crystal display without the transmitting part T.

When the present liquid crystal display is used in a dark environment, it may have an increased transmittance by driving a portion of the image displaying part C that displays black. When the portion of the image displaying part C that displays black is driven by an applied voltage, it displays white. When transmittance of the transmitting part T changes from 5% of the incident light source to 20% of the incident light source and the increased transmittance of the image displaying part C due to the driving are added, a total of transmittance of the image displaying part C and the transmitting part T may be increased from 5% of the incident light source to 40% of the incident light source.

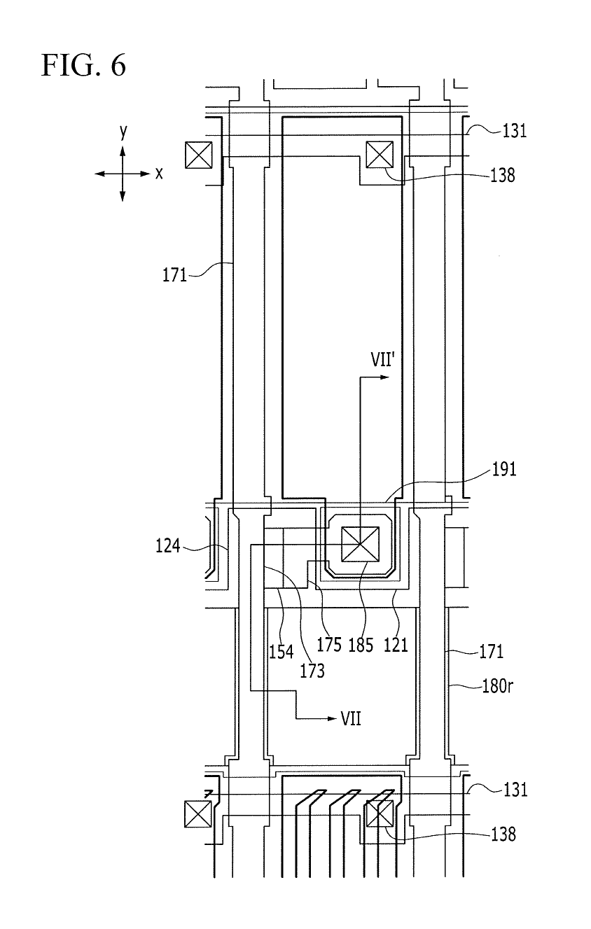

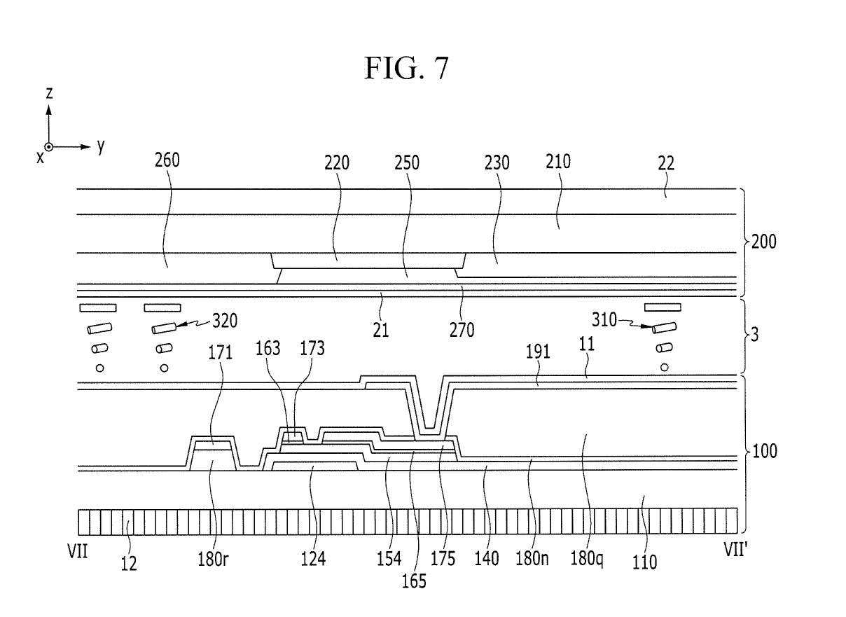

A liquid crystal display according to an exemplary embodiment of the present invention will be described with reference to FIGS. 6 and 7.

FIG. 6 is an enlarged layout view of the image displaying part and the transmitting part of a liquid crystal display according to an exemplary embodiment of the present invention. FIG. 7 is a cross-sectional view taken along a line VII-VII′ of FIG. 6, according to an exemplary embodiment of the present invention.

Referring to FIGS. 6 and 7, in the first display panel 100, the first polarizing plate 12 which may be polarized along the x axis direction and may be formed on the outer side of the first transparent substrate 110. The gate line 121, the gate electrode 124, the gate insulating layer 140, the semiconductor 154, the ohmic contacts 163 and 165, the third passivation layer 180r, the data line 171 including the source electrode 173, the drain electrode 175, the first passivation layer 180n, the second passivation layer 180q, the pixel electrode 191, and the first alignment layer 11 may be sequentially stacked on the first transparent substrate 110.

In the second display panel 200, the second polarizing plate 22 may be polarized along the y axis direction and may be formed on the outer side of the second transparent substrate 210. The color filter 230, the light blocking member 220, the transparent layer 260, the overcoat 250, the common electrode 270, and the second alignment layer 21 may be sequentially stacked on the second transparent substrate 210.

The liquid crystal layer 3 may be formed between the first display panel 100 and the second display panel 200.

The first alignment layer 11 and the second alignment layer 21 may be horizontal alignment layers and may include photoreaction material to be formed by a photo-alignment process.

The first alignment layer 11 may be formed by having an alignment layer irradiated by a polarized light in a direction which is parallel to the x axis. The polarization axis of the first polarizing plate 12 may extend along the x axis. The second alignment layer 21 may be formed by having an alignment layer irradiated by polarized light in a direction which is parallel to the y axis. The polarization axis of the second polarizing plate 22 may extend along the y axis.

The liquid crystal layer 3 may be injected between the first alignment layer 11 and the second alignment layer 21 and may include a nematic liquid crystal material having positive dielectric constant anisotropy (e.g., a twisted nematic liquid crystal). Among the liquid crystal molecules of the liquid crystal layer 3, the liquid crystal molecules on the first alignment layer 11 have long axes directions aligned to be parallel to the polarization axis of the first polarizing plate 12. The liquid crystal molecules below the second alignment layer 21 have long axes directions aligned to be in parallel to the polarization axis of the second polarizing plate 22. The liquid crystal molecules of the liquid crystal layer 3 may be aligned in a twisted structure (e.g., twisted nematic liquid crystals). The twisted structure may have a spiral shape that twists 90° from the first alignment layer 11 to the second alignment layer 21. The twisted spiral structure may have liquid crystal molecules aligned parallel to the polarizing axes of the first and second polarizing plates 12 and 22, respectively.

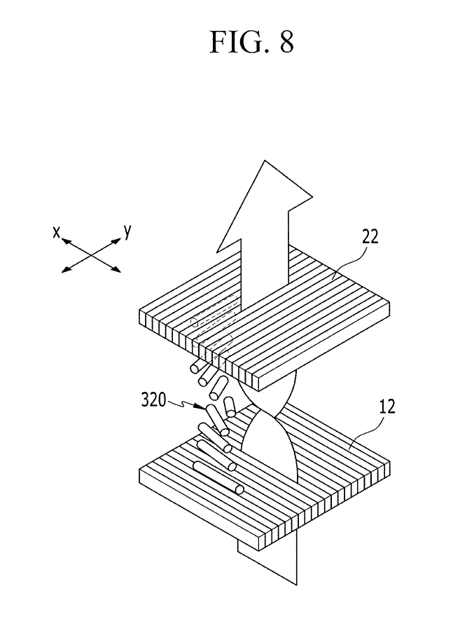

A driving effect of the liquid crystal display according to an exemplary embodiment of the present invention will be described with reference to FIGS. 7 and 8. FIG. 8 is an enlarged view schematically showing the first polarizing plate 12, the second polarizing plate 22, and the liquid crystal molecules 320 injected between the first polarizing plate 12 and the second polarizing plate 22 of the transmitting part T of FIG. 6, according to an exemplary embodiment of the present invention.

FIG. 8 shows the first polarizing plate 12 having a polarization axis in the x axis direction, the second polarizing plate 22 having a polarization axis in the y axis direction, and the liquid crystal molecules 320 of the transmitting part T between the first polarizing plate 12 and the second polarizing plate 22. The liquid crystal molecules 320 of the transmitting part T may be aligned in a twisted structure which has a spiral shape that twists 90°. The liquid crystal molecules 320 of the transmitting part T are aligned parallel to the polarization axis of the first polarizing plate 12 where they are adjacent to the first polarizing plate 12, parallel to the second polarization axis of the second polarizing plate 22 where they are adjacent to second polarizing plate 22, and twist 90° in a direction from the first polarizing plate 12 to the second polarizing plate 22. When no voltage is applied to the liquid crystal molecules 320 of the transmitting part T, light emitted from the backlight is polarized in the x axis direction by the first polarizing plate 12 and the polarized light passes through the liquid crystal molecules 320 of the transmitting part T. The polarized light, having passed through the first polarizing plate 12 and the liquid crystal molecules 320 of the transmitting part T, passes through the polarization axis of the second polarizing plate 22. An arrow in FIG. 8 indicates a progress direction of the polarized light passing through the liquid crystal molecules 320. Therefore, when no voltage is applied to the transmitting part T, the transmitting part T displays white. Accordingly, when no voltage is applied to the transmitting part T and the transmitting part T displays white, the transmitting part T is in the normally white mode.

In an exemplary embodiment of the inventive concept, with reference to FIG. 7, the alignment direction of the liquid crystal molecules 310 of the image displaying part C is the same as the alignment direction of the liquid crystal molecules 320 of the transmitting part T. When no voltage is applied to the liquid crystal molecules 310 of the image displaying part C, light emitted from the backlight is polarized in the x axis direction by the first polarizing plate 12. The polarized light passes through the liquid crystal molecules 310 of the image displaying part C. The polarized light, having passed through the liquid crystal molecules 310 of the image displaying part C, passes through the polarization axis of the second polarizing plate 22. Thus, the image displaying part C is in the normally white mode. Therefore, when no voltage is applied to the image displaying part C, the image displaying part C displays white. However, unlike the transmitting part T to which a voltage is not applied, the image displaying part C is driven by rotating the liquid crystal molecules 310 of the image displaying part C disposed between the two electrodes 191 and 270 in a direction which is in parallel to a direction of the electric field generated by the pixel electrode 191 and the common electrode 270.

The present invention is not limited to the exemplary embodiments thereof described above. For example, according to an exemplary embodiment of the present invention, when voltage is not applied to the image displaying part C, the image displaying part C may be aligned in the normally black mode, unlike the transmitting part T. When the image displaying part C is in the normally black mode, light is not transmitted by the image displaying part C. For example, when the polarization axis of the first polarizing plate 12 extends along the x axis direction and the polarization axis of the second polarizing plate 22 extends along the y axis direction, the long axes of the liquid crystal molecules 310 of the image displaying part C may be aligned in a z axis.

The alignment of the liquid crystal molecules 320 of the transmitting part T is not limited to the exemplary embodiment of the present invention described above with reference to FIG. 7. The alignment direction of the liquid crystal molecules 320 of the transmitting part T may be modified so the transmitting part T may transmit light when voltage is not applied thereto. For example, the polarization axis of the first polarizing plate 12 may extend along the y axis. The liquid crystal molecules immediately on the first alignment layer 11 may be aligned to be parallel to the y axis. The polarization axis of the second polarizing plate 22 may extend along the x axis. The liquid crystal molecules immediately on the second alignment layer 21 may be aligned to be parallel to the x axis. The liquid crystal molecules 320 may be aligned in a spiral structure that twists 90° along an upward direction, starting above the first alignment layer 11, to the second alignment layer 12.

A method of manufacturing the liquid crystal display according to an exemplary embodiment of the present invention will be described with reference to FIGS. 1 to 5 and 9.

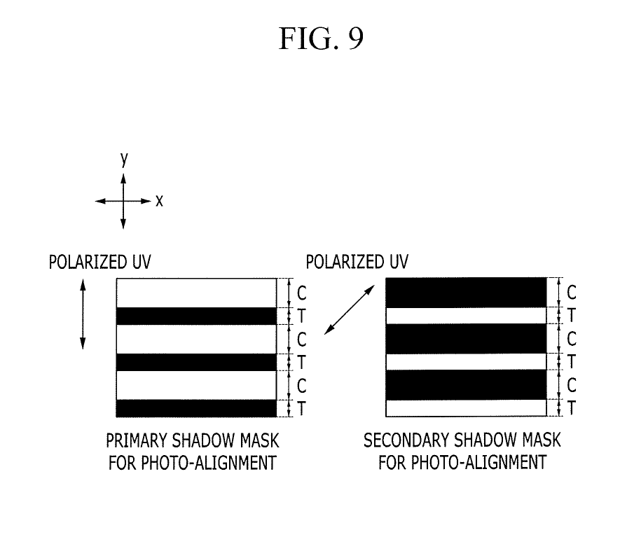

FIG. 9 is a view schematically showing a mask used in a method of manufacturing a liquid crystal display according to an exemplary embodiment of the present invention, with reference to FIG. 1.

The liquid crystal display, according to an exemplary embodiment of the present invention, with reference to FIG. 1 may be formed by sequentially stacking the gate line 121, the gate electrode 124, the gate insulating layer 140, the semiconductor 154, the ohmic contacts 163 and 165, the third passivation layer 180r, the data line 171 including the source electrode 173, the drain electrode 175, the first passivation layer 180n, the second passivation layer 180q, the common electrode 270, the fourth passivation layer 180z, the pixel electrode 191, and the first alignment layer 11 on the first transparent substrate 110 of the first display panel 100. Since a description of the arrangement of the above-mentioned elements is the same as that of FIGS. 1 to 3 described above, a duplicate description thereof will be omitted for brevity.

The first alignment layer 11 may be formed using a mask having the same pattern as a primary and a secondary shadow mask for photo-alignment as shown in FIG. 9. The first alignment layer 11 may be formed by having an alignment layer irradiated by a polarized light in a direction forming an angle of 0° with respect to the y axis using the primary shadow mask of FIG. 9 as a mask. The primary shadow mask for photo-alignment of FIG. 9 includes a mask pattern having a portion corresponding to the image displaying part C at a maximum gray scale and having a portion corresponding to the transmitting part T at a minimum gray scale.

In addition, the first alignment layer 11 may be formed by having an alignment layer irradiated by polarized light in a direction forming an angle of 45° with the x axis using the secondary shadow mask for photo-alignment as a mask. The secondary shadow mask for photo-alignment of FIG. 9 includes a portion corresponding to the image displaying part C at the minimum gray scale and a portion corresponding to the transmitting part T at the maximum gray scale.

The first alignment layer 11 may also be formed by first having an alignment layer irradiated by polarized light in a direction forming an angle of 45° with the x axis using the secondary shadow mask for photo-alignment of FIG. 9 as a mask (e.g., a mask having a portion corresponding to the image displaying part C at the minimum gray scale and a portion corresponding to the transmitting part T at the maximum gray scale), and then having the light alignment layer irradiated by polarized light in a direction forming an angle of 0° with respect to the y axis using the primary shadow mask for photo-alignment of FIG. 9 (e.g., a mask pattern having a portion corresponding to the image displaying part C at a maximum gray scale and having a portion corresponding to the transmitting part T at a minimum gray scale).

The second alignment layer 21 may also be formed according to the same method as the method used to form the first alignment layer 11. The light blocking member 220, the color filter 230, the transparent layer 260, the overcoat 250, and the second alignment layer 21 may be disposed on the second transparent substrate 210 of the second display panel 200.

A sealant may be formed between the first display panel 100 and the second display panel 200. The liquid crystal layer 3 may be injected between the first display panel 100 and the second display panel 200. The liquid crystal molecules may be positive crystal molecules.

The liquid crystal molecules 310 and 320 of the liquid crystal layer 3 may have an initial alignment angle determined by the first and second alignment layers 11 and 21. The liquid crystal molecules 310 of the image displaying part C may be aligned by the first alignment layer 11 in a direction in which the direction of the long axis of the liquid crystal molecule 310 forms an angle of 0° with respect to the y axis. The liquid crystal molecules 320 of the transmitting part T may be aligned by the second alignment layer 21 in a direction in which the direction of the long axis of the liquid crystal molecule 320 forms an angle of 45° with respect to the x axis.

The first polarizing plate 12 having the polarization axis extend along the x axis is disposed on an outer side of the first transparent substrate 110. The second polarizing plate 22 having the polarization axis extend along the y axis is disposed on an outer side of the second transparent substrate 210.

A method of manufacturing a liquid crystal display according to an exemplary embodiment of the present invention, which may be different from the method of manufacturing the liquid crystal display according to an exemplary embodiment of the present invention described above with reference to FIGS. 1 to 5 will be described.

According to an exemplary embodiment of the present invention, forming the alignment layers 11 and 21 includes radiating polarized light in a direction forming the angle of 0° with respect to the polarization axis of the second polarizing plate 22 and radiating polarized light in the direction forming the angle of 40° or more to 50° or less with respect to the polarization axis of the first polarizing plate 12. When the alignment directions of the liquid crystal molecules 310 and 320 are changed according to various exemplary embodiments of the present invention as described above, according to the changed alignment direction, forming the alignment layers 11 and 21 may include radiating the polarized light in the direction forming the angle of −5° or more to 5° or less with respect to any one of the polarization axes of the first polarizing plate 12 and the second polarizing plate 22 and radiating the polarized light in the direction forming the angle of 40° or more to 50° or less with respect to any one of the polarization axes of the first polarizing plate 12 and the second polarizing plate 22.

In addition, unlike the mask of FIG. 9 in which the maximum gray scale and minimum gray scale patterns are alternately extended along a row, according to one or more exemplary embodiments of the present invention, a mask may have the maximum gray scale and minimum gray scale patterns alternately extended along a column. According to an exemplary embodiment of the present invention, a mask may have the maximum gray scale and minimum gray scale patterns alternately repeated on one row. In addition, the mask pattern may be variously changed according to possible various arrangements of the image displaying part C and the transmitting part T without departing from the scope of the present invention.

According to an exemplary embodiment of the present invention, the alignment layers 11 and 21 may be formed by a rubbing method.

While the inventive concept has been described with reference to exemplary embodiments thereof, it is to be understood that the present invention is not limited to the disclosed exemplary embodiments. The present invention may include various modifications and equivalent arrangements of the exemplary embodiments thereof described above.

What is claimed is:

1. A liquid crystal display comprising:
a first transparent substrate having an image displaying part and a transmitting part;
a second transparent substrate opposite to the first transparent substrate;
a liquid crystal layer formed between the first transparent substrate and the second transparent substrate;
a first polarizing plate disposed on a side of the first transparent substrate; and
a second polarizing plate disposed on a side of the second transparent substrate,
wherein the transmitting part is in a normally white mode in which light travels through the liquid crystal layer in an absence of an electrical field provided thereacross.

2. The liquid crystal display of claim 1, further comprising
a common electrode having an opening part in the transmitting part.

3. The liquid crystal display of claim 2, wherein
the first polarizing plate and the second polarizing plate are linear polarizing plates and have polarization axes directions which are perpendicular to each other, and
liquid crystal molecules of the liquid crystal layer of the transmitting part are aligned at an angle of 40° or more to 50° or less with respect to a polarization axis direction of the first polarizing plate or a polarization axis direction of the second polarizing plate.

4. The liquid crystal display of claim 1, wherein
the image displaying part is in a normally black mode in which light is blocked by the liquid crystal layer in an absence of an electrical field provided thereacross.

5. The liquid crystal display of claim 4, wherein
the image displaying part and the transmitting part include the same liquid crystal molecules in the liquid crystal layer and an alignment direction of a liquid crystal molecule of the liquid crystal layer of the image displaying part is different from an alignment direction of a liquid crystal molecule of the liquid crystal layer of the transmitting part.

6. The liquid crystal display of claim 5, wherein
the polarization axis of the first polarizing plate and the polarization axis of the second polarizing plate are perpendicular to each other,
the liquid crystal molecules of the liquid crystal layer of the transmitting part are aligned at an angle of 40° or more to 50° or less with respect to a polarization axis direction of the first polarizing plate or a polarization axis direction of the second polarizing plate, and
the liquid crystal molecules of the image displaying part of the liquid crystal layer are aligned at an angle of −5° or more to 5° or less with respect to a polarization axis direction of the first polarizing plate or a polarization axis direction of the second polarizing plate.

7. The liquid crystal display of claim 6, wherein
the image displaying part includes:
a thin film transistor formed on an inner side of the first transparent substrate,
a pixel electrode formed on the thin film transistor, and
a color filter formed on an inner side of the first transparent substrate or the second transparent substrate.

8. The liquid crystal display of claim 7, comprising a common electrode, wherein the common electrode has an opening part in the transmitting part.

9. The liquid crystal display of claim 8, wherein
the common electrode and the pixel electrode overlap with each other and wherein the common electrode and the pixel electrode have an insulating layer disposed therebetween.

10. The liquid crystal display of claim 9, wherein
the transmitting part further comprises a transparent layer.

11. The liquid crystal display of claim 10, wherein
an area of the image displaying part is formed at a ratio of 5:5 to 8:2 and an area of the transmitting part is formed at a ratio of 5:5 to 8:2.

12. The liquid crystal display of claim 11, wherein
the transmitting part has a transmittance of 5% or more to 20% or less of an incident light source.

13. The liquid crystal display of claim 12, wherein
when an electric field is applied between the common electrode and the pixel electrode, a total of transmittance of the image displaying part and the transmitting part is increased from 5% to 40% of the incident light source by driving the image displaying part.

14. The liquid crystal display of claim 6, wherein
the liquid crystal layer of the transmitting part of the liquid crystal layer has a thickness of 3 μm or more to 4 μm or less.

15. The liquid crystal display of claim 2, wherein
the first polarizing plate and the second polarizing plate are linear polarizing plates and have polarization axes directions which are perpendicular to each other, and
the liquid crystal molecules of the transmitting part of the liquid crystal layer are aligned in a twisted nematic (TN) mode.

16. A method of manufacturing a liquid crystal display, comprising:
forming a first alignment layer on an inner side of a first transparent substrate, the first transparent substrate having an image displaying part and a transmitting part;
disposing a first polarizing plate having a polarization axis extend along a first direction on a side of the first transparent substrate, and
disposing a second polarizing plate having a second polarization axis on a side of a second transparent substrate, the second transparent substrate being opposite to the first transparent substrate, wherein the first and second polarizing axes are perpendicular to each other,
wherein forming the first alignment layer includes having the first alignment layer irradiated by polarized light in a direction forming an angle of −5° or more to 5° or less with respect to either the first polarization axis or the second polarization axis using a mask having an image displaying part of the first alignment layer at a maximum gray scale and having a transmitting part of the first alignment layer at a minimum gray scale, and having the first alignment layer irradiated by polarized light in a direction forming an angle of 40° or more to 50° or less with respect to either the first polarization axis or the second polarization axis using a mask having the image displaying part of the first alignment layer at the minimum gray scale and having the transmitting part of the first alignment layer at the maximum gray scale.

17. The method of claim 16, further comprising
forming a second alignment layer on an inner side of the second transparent substrate, wherein forming the second alignment layer includes having the second alignment layer radiated by polarized light in a direction forming an angle of −5° or more to 5° or less with respect to either the first polarization axis or the second polarization axis using a mask having an image displaying part of the second alignment layer at a maximum gray scale and having a transmitting part of the second alignment layer at a minimum gray scale, and having the second alignment layer radiated by polarized light in a direction forming an angle of 40° or more to 50° or less with respect to either the first polarization axis or the second polarization axis using a mask having the image displaying part of the first alignment layer at the minimum gray scale and having the transmitting part of the first alignment layer at the maximum gray scale.

18. A liquid crystal display comprising:
a first transparent substrate having an image displaying part and a transmitting part;
a second transparent substrate;
a liquid crystal layer formed between the first transparent substrate and the second transparent substrate;
a first polarizing plate disposed below the first transparent substrate; and
a second polarizing plate disposed above the second transparent substrate,
wherein the image displaying part includes a pixel electrode disposed between the first transparent substrate and the second transparent substrate, wherein the image displaying part includes a common electrode disposed between the first transparent substrate and the second transparent substrate, and wherein the transmitting part does not have either the pixel electrode or the common electrode.

19. The liquid crystal display of claim 18, wherein the total transmittance of the image displaying part and the transmitting part is increased from 5% to 40% of the incident light source by driving the image displaying part.

20. The liquid crystal display of claim 18, wherein
an area of the image displaying part is formed at a ratio of 5:5 to 8:2 and an area of the transmitting part is formed at a ratio of 5:5 to 8:2.
